(19) United States
(12) Patent Application Publication
(10) Pub. No.: US 2014/0298319 A1
(43) Pub. Date: Oct. 2, 2014

(54) METHOD FOR INSTALLING OPERATING SYSTEM ON ELECTRONIC DEVICE

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: HONG-LIAN HUANG, Shenzhen (CN); JIAN LUO, Shenzhen (CN); MEI HUANG, Shenzhen (CN); JIAN-SHE SHEN, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/228,270

(22) Filed: Mar. 28, 2014

(30) Foreign Application Priority Data
Mar. 28, 2013 (CN) 2013101040711

(51) Int. Cl. G06F 12/02; G06F 9/445

(52) U.S. Cl. CPC G06F 12/0246; G06F 8/61
USPC 717/174

(57) ABSTRACT

A method for installing an operating system one or a great number of electronic devices includes steps of burning the operating system onto an NAND flash memory. The boot file of the operating system is captured from the NAND flash memory. The electronic device having been burnt the boot file of the operating system is connected to the USB flash stick storing the kernel file of the operating system. The electronic device is started up. The boot file of the operating system is run from the NAND flash memory of the electronic device, so accessing the kernel file of the operating system from the USB flash stick to make all system applications of the kernel files of the operating system have been executed.

### BACKGROUND

1. Technical Field

The present disclosure relates to a method for installing an operating system on an electronic device.

2. Description of Related Art

Electronic devices such as computers, mobile phones and tablet computers must have operating systems. A machine is needed for copying an operating system and burning the operating system onto the main board of the electronic device in the factory. However, installing the operating system on a large number of electronic devices with the machine is time consuming. Furthermore, when the operating system to be installed on the electronic device is updated, the machine must be updated accordingly, which increases the cost of the electronic device.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of an embodiment of an electronic device connecting to a USB flash stick.

FIG. 2 is a block diagram of an embodiment of an auxiliary device and tools applied to install an operating system on the electronic devices, such as the one of FIG. 1.

FIG. 3 is a flowchart of a method for installing an operating system on electronic devices, such as the one of FIG. 1.

### DETAILED DESCRIPTION

Flash memories such as Not And (NAND) flash memories are used in electronic devices since the flash memories have high capacity and high access speed. It is a feasible solution to installing an operating system on an electronic device via a Universal Serial Bus (USB) driver and a USB flash disk such as USB flash stick instead of a Digital Video Disk (DVD) disk. The USB driver is present in the electronic device. The USB flash stick is an external component of the electronic device. The NAND flash memory can also be driven by the USB driver. The method provided by the present disclosure relates to installing an operating system on an electronic device via the USB driver and the NAND flash memory installed in the electronic device.

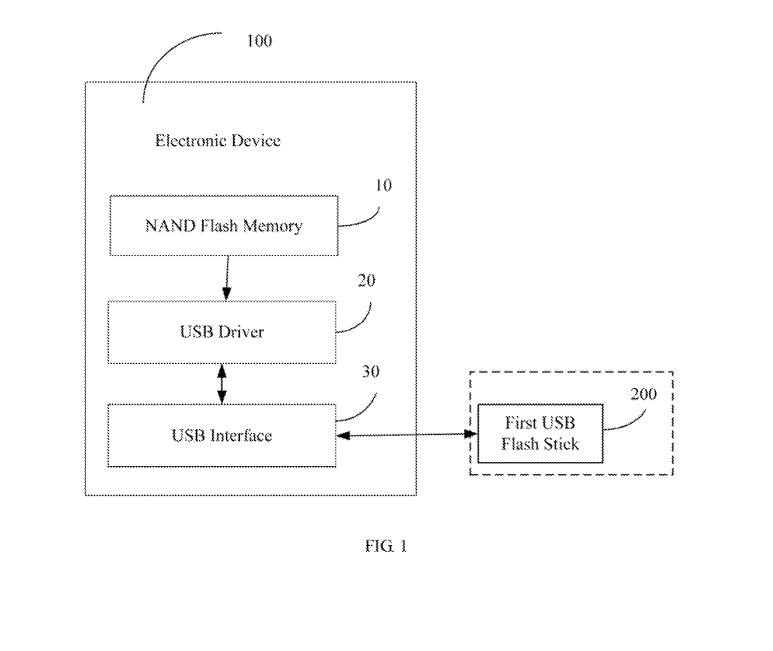

FIG. 1 shows an exemplary electronic device 100 and a first USB flash stick 200. The electronic device 100 includes an NAND flash memory 10, a USB driver 20, and a USB interface 30. The first USB flash stick 200 is an external component of the electronic device 100 and connects to the USB interface 30 of the electronic device 100.

The operating system to be installed on the electronic device 100 includes a boot file and a kernel file. The kernel file of the operating system is pre-stored in the first USB flash stick 200. In detail, the kernel file of the operating system is pre-stored in the root directory of the first USB flash stick 200. The operating system can be installed on the electronic device 100 via the first USB flash stick 200 and the NAND flash memory 10 installed in the electronic device 100 when the electronic device 100 connects to the first USB flash stick 200.

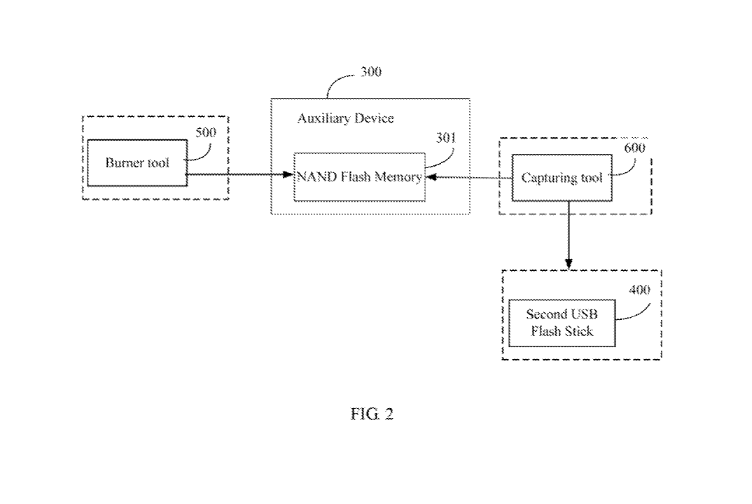

FIG. 2 shows an auxiliary device 300 applied to install the operating system on the electronic device 100. The auxiliary device 300 is a demonstration board of the electronic device 100 and at least includes a NAND flash memory 301. FIG. 2 also shows a burner tool 500 and a capturing tool 600. The burner tool 500 and the capturing tool 600 are applied to install the operating system on the electronic device 100 with the auxiliary device 300.

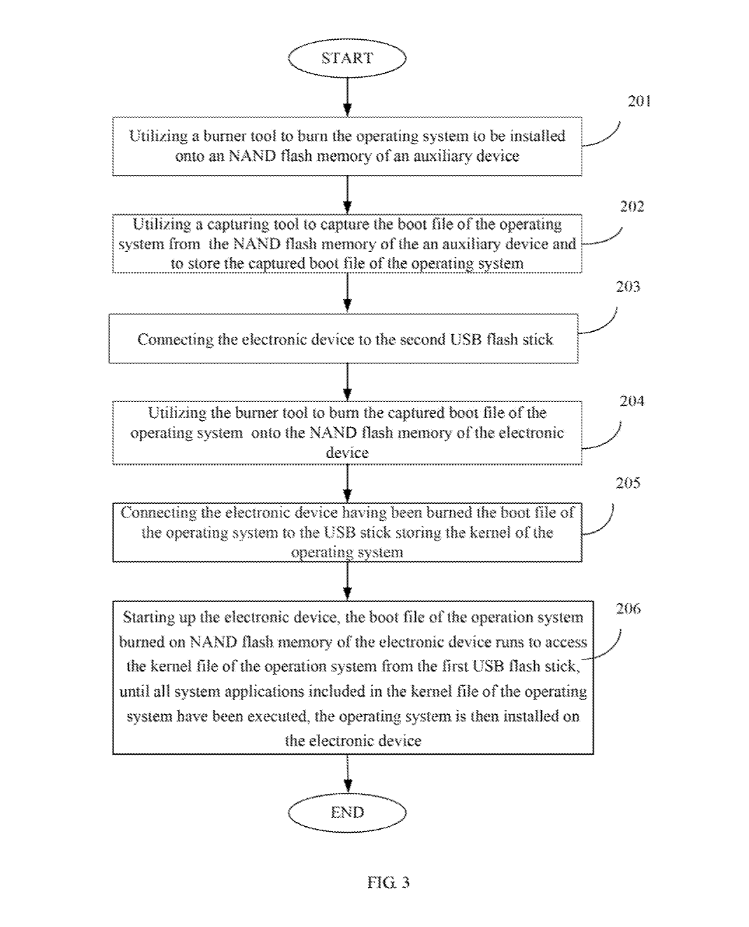

FIG. 3 shows a flowchart of a method for installing the operating system on the electronic device 100. The method includes the following steps, each of which is related to the various components contained in the electronic device 100. The steps of the method are further related to the first USB flash stick 200, the auxiliary device 300 and the second USB flash stick 400. The method is also related to a number of tools such as the burner tool 500 and the capturing tool 600.

In step S201, utilizing a burner tool 500 to burn the operating system to be installed on the electronic device 100 onto the NAND flash memory 301 of the auxiliary device 300.

In step S202, utilizing a capturing tool 600 to capture the boot file of the operating system from the first block of the NAND flash memory 301 of the auxiliary device 300 and to store the captured boot file of the operating system in the second USB flash stick 400. In the embodiment, the capturing tool is a burner tool of the NAND flash memory 301.

In step S203, connecting the electronic device 100 to the second USB flash stick 400.

In step S204, utilizing the burner tool 500 to burn the captured boot file of the operating system onto the NAND flash memory 10 of the electronic device 100 which requires the operating system.

In step S205, connecting the electronic device 100 to the first USB flash stick 200 storing the kernel of the operating system.

In step S206, starting up the electronic device 100, the boot file of the operating system burned on NAND flash memory 10 of the electronic device 100 automatically runs to access the kernel file of the operating system from the first USB flash stick 200, until all system applications included in the kernel file of the operating system have been executed, the operating system is then installed on the electronic device 100.

Although the present disclosure has been described in considerable detail with reference to certain preferred embodiments thereof, the disclosure is not for limiting the scope of the disclosure. Persons having ordinary skill in the art may make various modifications and changes without departing from the scope and spirit of the disclosure. Therefore, the scope of the appended claims should not be limited to the description of the preferred embodiments described above.

What is claimed is:

1. A method for installing an operating system on an electronic device, the electronic device comprising an NAND flash memory, a USB flash stick and a USB driver; the method comprising:
burning the operating system onto an NAND flash memory of an auxiliary device;
capturing a boot file of the operating system from the NAND flash memory of the auxiliary device;
burning the captured boot file of the operating system onto the NAND flash memory of the electronic device;
connecting the electronic device having been burned the boot file of the operating system to a USB flash stick storing a kernel file of the operating system;
starting up the electronic device connected to the USB flash stick;
running the boot file of the operating system from the NAND flash memory of the electronic device; and
accessing the kernel file of the operating system from the USB flash stick, to complete the installation of the operating system on the electronic device when all system applications of the kernel files of the operating system have been executed.

2. The method as described in claim 1, wherein the boot file of the operating system is captured from the NAND flash memory of the auxiliary device via a capture tool.

3. The method as described in claim 2, wherein the boot file of the operating system is captured from the first block of the NAND flash memory.

4. The method as described in claim 3, wherein the capturing tool is a burner tool.

5. The method as described in claim 4, wherein the auxiliary device is a demonstration board of the electronic device.

6. The method as described in claim 1, wherein the kernel file of the operating system is stored in the root directory of the USB flash stick.
